(19) United States
(12) Patent Application Publication
(10) Pub. No.: US 2023/0153062 A1
(43) Pub. Date: May 18, 2023

(54) VERBAL INTERFACE SYSTEMS AND METHODS FOR VERBAL CONTROL OF DIGITAL DEVICES

(71) Applicant: Saint Louis University, St. Louis, MO (US)

(72) Inventor: Richard D. Bucholz, St. Louis, MO (US)

(21) Appl. No.: 17/996,881

(22) PCT Filed: Apr. 21, 2021
(86) PCT No.: PCT/US2021/028358

§ 371 Date: Oct. 21, 2022

Related U.S. Application Data
(60) Provisional application No. 63/013,251, filed on Apr. 21, 2020.

(51) Int. Cl. G06F 3/16; G06F 3/038; G06F 3/023; G06V 20/60; G10L 15/22; G10L 15/30; G10L 25/57

(52) U.S. Cl. CPC G06F 3/167; G06F 3/038; G06F 3/023; G06V 20/60; G10L 15/22; G10L 15/30; G10L 25/57; G06V 2201/02; G10L 2015/223

(57) ABSTRACT

Provided herein are systems and methods to verbally control a host computer for data entry into the computer, such as for electronic medical record data entry. The verbal interface system may be operable to receive, via a connection interface, at least one video capture of the host computer display; analyze the at least one video capture to determine a plurality of data entry fields displayed on the host computer display; receive, via a microphone, a verbal command correlating to at least one of the plurality of data entry fields; and autonomously control the mouse and/or the keyboard to perform mouse and/or text input into the host computer.

### CROSS-REFERENCE TO RELATED APPLICATIONS

This application claims priority to U.S. Provisional Application No. 63/013,251, filed Apr. 23, 2020, the contents of which are entirely incorporated by reference herein.

### FIELD

The present disclosure relates to systems and methods for verbal control of digital devices. More specifically, the disclosure relates to verbal control of digital devices using a serial interface.

### BACKGROUND

Computational devices are controlled via a variety of human interfaces, such as mice, keyboards, video displays, and microphones to enable voice recognition devices.

Voice recognition devices are currently used to control computational devices in the commercial and private sector only in simple control applications such as turning on or off devices, initiating playback, or executing a string of simple commands. As voice recognition devices do not receive feedback from a controlled device they may not execute commands properly. For example, a voice command could be interpreted incorrectly resulting in an error message appearing on a video display; however, as the voice recognition device does not have access to the video display it cannot learn that it has executed the command incorrectly.

There are situations in which users cannot or would prefer not to employ the mechanical interface of a mouse and keyboard, a notable instance being healthcare. Frequently medical users must use their hands at the same time as generating data (such as performing a medical examination) or cannot touch a non-sterile interface during the performance of surgery, which precludes the use of a mechanical interface. Further, touching a mechanical interface poses the risk of contact contamination, an important consideration both in the medical workplace and in the public commons given the recent pandemic.

Therefore, there is a need for improved verbal control of digital devices, particularly in healthcare.

### SUMMARY

This disclosure provides a verbal interface system for a host computer for performing data entry. The host computer may have a standard interface including a mouse, a keyboard, and a display. The verbal interface system may include at least one connection interface in communication with the host computer; a memory device; a verbal interface software program stored on the memory device; a microphone; and a processor. The processor may be configured to execute instructions stored on the verbal interface software program to: receive, via the connection interface, at least one video capture of the host computer display; analyze the at least one video capture to determine a plurality of data entry fields displayed on the host computer display; receive, via the microphone, a verbal command correlating to at least one of the plurality of data entry fields; and autonomously control the mouse and/or the keyboard to perform mouse and/or text input into the host computer.

In some aspects, the verbal interface system may further include a speaker, wherein the processor is further configured to: generate a plurality of prompts, each one of the plurality of prompts corresponding to one of the plurality of data entry fields; and suggest, via the speaker, the plurality of prompts. In additional aspects, the verbal interface system may further include at least one network connection port in communication with a network, the network having access to a speech recognition program, wherein the processor is further configured to: translate the verbal command, via the speech recognition software, into a selection of the one of the plurality of data entry fields corresponding to the one of the plurality of prompts indicated.

In an aspect, autonomously controlling the mouse and/or the keyboard to perform mouse and/or text input into the host computer may include: transmitting to the host computer, via the connection interface, by emulating mouse input and/or keyboard input, a selection of one of the plurality of data entry fields and/or an alphanumeric sequence to be entered into the one of the plurality of data entry fields selected.

In various aspects, the at least one connection interface is a USB 3 interface, a USB 2 interface, or a radiofrequency connection. The verbal interface system may further include a video screen capture device in connection with the USB 2 interface and a video output port of the host computer; and an external display monitor in connection with the host computer and the video screen capture device.

In some aspects, the at least one video capture of the host computer display is a plurality of video captures obtained during manual data entry performed via the mouse and the keyboard. The processor may be further configured to: analyze the video capture to determine a pattern of manual data entry, and generate ways to allow verbal data entry without interrupting the pattern of manual data entry. In some aspects, the plurality of data entry fields comprises patient information or treatment information.

Further provided herein is a method of performing data entry on a host computer using a verbal interface system. The method may include receiving, via a connection interface on the verbal interface system, at least one video capture of a display on the host computer; analyzing the at least one video capture to determine a plurality of data entry fields displayed on the host computer display; receiving, via a microphone on the verbal interface system, a verbal command correlating to at least one of the plurality of data entry fields; and autonomously controlling a mouse and/or a keyboard on the host computer to perform mouse and/or text input into the host computer.

In some aspects, the method may further include: generating a plurality of prompts, each one of the plurality of prompts corresponding to one of the plurality of data entry fields; and suggesting, via a speaker on the verbal interface system, the plurality of prompts. In other aspects, the method may further include: translating the verbal command, via a speech recognition software accessible to the verbal interface system through at least one network connection, into a selection of the one of the plurality of data entry fields corresponding to the one of the plurality of prompts indicated.

In an aspect, autonomously controlling the mouse and/or the keyboard to perform mouse and/or text input into the host computer may include transmitting to the host computer, via the connection interface, by emulating mouse input and/or keyboard input, a selection of one of the plurality of data entry fields and/or an alphanumeric sequence to be entered into the one of the plurality of data entry fields selected.

In an aspect, the method may further include capturing the at least one video capture using a video screen capture device in connection with the connection interface; and displaying the at least one video capture using an external display monitor in connection with the host computer and the video screen capture device.

In some aspects, the method may further include: observing manual data entry performed via the mouse and the keyboard via the at least one video capture of the host computer display; analyzing the video capture to determine a pattern of manual data entry; and generating ways to allow verbal data entry without interrupting the pattern of manual data entry.

Other aspects and iterations of the invention are described more thoroughly below.

### BRIEF DESCRIPTION OF THE DRAWINGS

The description will be more fully understood with reference to the following figures and data graphs, which are presented as various embodiments of the disclosure and should not be construed as a complete recitation of the scope of the disclosure. It is noted that, for purposes of illustrative clarity, certain elements in various drawings may not be drawn to scale. Understanding that these drawings depict only exemplary embodiments of the disclosure and are not therefore to be considered to be limiting of its scope, the principles herein are described and explained with additional specificity and detail through the use of the accompanying drawings in which:

FIG. 1 is a diagram showing the main components of the verbal interface system (VIS), in one example.

FIG. 2 is an example VIS connecting to a controlled computational device.

FIG. 3 is an example VIS connecting to a controlled computational device.

FIG. 4 is an example VIS connecting to a controlled computational device.

FIG. 5 is an example VIS connecting to a controlled computational device.

FIG. 6 is a flowchart for a method of controlling a host computer using a VIS.

FIG. 7 is a flowchart for a method of controlling a host computer using a VIS.

Reference characters indicate corresponding elements among the views of the drawings. The headings used in the figures do not limit the scope of the claims.

### DETAILED DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure. Thus, the following description and drawings are illustrative and are not to be construed as limiting. Numerous specific details are described to provide a thorough understanding of the disclosure. However, in certain instances, well-known or conventional details are not described in order to avoid obscuring the description.

Reference to “one embodiment”, “an embodiment”, or “an aspect” means that a particular feature, structure, or characteristic described in connection with the embodiment is included in at least one embodiment of the disclosure. The appearances of the phrase “in one embodiment” or “in one aspect” in various places in the specification are not necessarily all referring to the same embodiment, nor are separate or alternative embodiments mutually exclusive of other embodiments. Moreover, various features are described which may be exhibited by some embodiments and not by others.

As used herein, the terms “comprising,” “having,” and “including” are used in their open, non-limiting sense. The terms “a,” “an,” and “the” are understood to encompass the plural as well as the singular. Thus, the term “a mixture thereof” also relates to “mixtures thereof.”

The terms used in this specification generally have their ordinary meanings in the art, within the context of the disclosure, and in the specific context where each term is used. Alternative language and synonyms may be used for any one or more of the terms discussed herein, and no special significance should be placed upon whether or not a term is elaborated or discussed herein. In some cases, synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any example term. Likewise, the disclosure is not limited to various embodiments given in this specification.

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

The essential serial nature of voice recognition is far from optimal for performing more complex control applications with a digital system, such as data entry, as only single utterances can be used at a time, selection of an entry field is difficult with voice, and changes in the controlled system are not recognized by the verbal recognition system. Further, verbal recognition is frequently user specific, and when interacting with a public system, personal nuances in speech will not be properly accommodated by a generic speech recognition algorithm.

In addition, the majority of computational devices are not optimally controlled via sequential entry of commands, but rather, an interface incorporating a video display allowing multiple choices to be shown simultaneously which can be selected and modified with a pointing device, such as a mouse, in conjunction with a keyboard. In a standard paradigm, a menu of choices is displayed on a screen, the user selects specific items using a mouse and then enters a specific choice or text using either a keyboard to type a response or a mouse to select from a drop-down menu. Once all choices have been made on a specific screen-displayed form, the completed form is submitted to the digital device for processing. This paradigm enables multiple interactions by the user, does not force the user to address all data items as some can be answered using default settings, and then confirmation of correctness by the user prior to submission, thereby allowing entry of multiple data items quickly.

It is frequently necessary to execute a route series of mouse clicks and keyboard entries to complete a task using a computer, such as ordering a test, or documenting a normal examination. Allowing a user to automate such repetitive entries using a voice controlled command created by the user for that specific purpose would allow rapid completion of documentation tasks within healthcare and other computer based interactions.

In certain situations a user of a computational device may need immediate assistance in interpreting what the system is displaying, how to respond to error messages, or assistance in dealing with interpretation of data being displayed. Particularly in healthcare, medical computational devices do not allow the user to decide when, if, and how much data is to be shared in an emergent situation. The interface proposed in this disclosure would be equipped with an independent connection to the Internet which would allow the user to share data and error messages displayed by the controlled system using verbal utterances, and to share control of the controlled system with a remote consultant as well. Further, by training the proposed device or connection of the device to reference sources on the Internet the controlled system could be continuously monitored for situations that need immediate attention either by the user or by a remote expert. The need for a touchless, intuitive human machine interface, empowered by artificial intelligence and connected to the Internet to assist the user in complex and time criteria situations has been emphasized by recent events and suggest utility across a broad spectrum of users interacting with computers.

Provided herein are systems and methods for verbal control of digital devices using a serial interface that address the foregoing problems. In various embodiments, the serial interface may be a verbal interface system (VIS). The VIS may be connected to a host computer. The host computer may be any standard computer (e.g. a controlled computational device, “CCD”) to allow complete verbal control of the CCD. In various embodiments, the VIS autonomously controls inputs into the CCD, via voice commands received from the VIS.

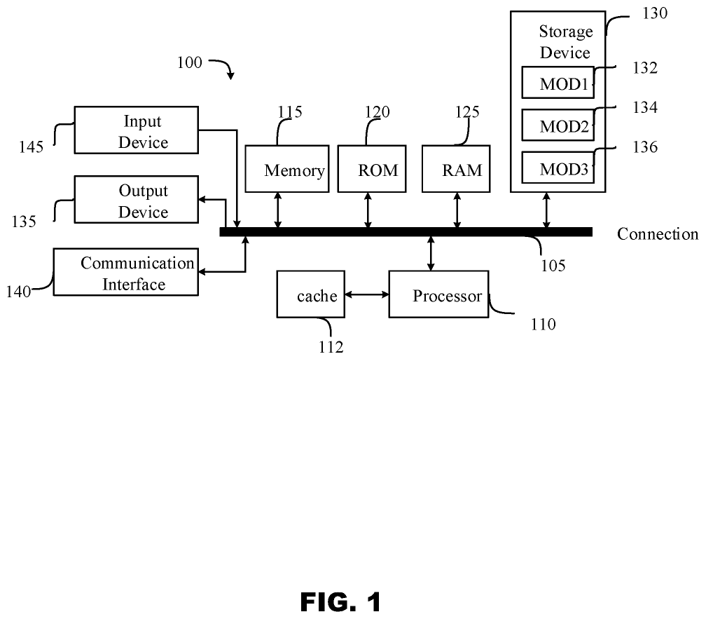

The VIS may include a processor, memory, a network connection to the Internet, and a connection interface to the CCD. In some embodiments, the connection interface to the CCD may be operable to connect to one or more human interface devices. In an example, a VIS may include a computing system having at least one processor for controlling a CCD. FIG. 1 shows an example of computing system 100, or VIS, in which the components of the system are in communication with each other using connection 105. Connection 105 can be a physical connection via a bus, or a direct connection into processor 110, such as in a chipset or system-on-chip architecture. Connection 105 can also be a virtual connection, networked connection, or logical connection.

In some examples, one or more of the described system components represents many such components each performing some or all of the function for which the component is described. In some examples, the components can be physical or virtual devices.

Example system 100 includes at least one processing unit (CPU or processor) 110 and connection 105 that couples various system components including system memory 115, read only memory (ROM) 120 or random access memory (RAM) 125 to processor 110. Computing system 100 can include a cache of high-speed memory 112 connected directly with, in close proximity to, or integrated as part of processor 110.

Processor 110 can include any general purpose processor and a hardware service or software service, such as services 132, 134, and 136 stored in storage device 130, configured to control processor 110 as well as a special-purpose processor where software instructions are incorporated into the actual processor design. Processor 110 may essentially be a completely self-contained computing system, containing multiple cores or processors, a bus, memory controller, cache, etc. A multi-core processor may be symmetric or asymmetric.

To enable user interaction, computing system 100 includes an input device 145, which can represent any number of input mechanisms. Computing system 100 can also include output device 135, which can be one or more of a number of output mechanisms known to those of skill in the art. In some instances, multimodal systems can enable a user to provide multiple types of input/output to communicate with computing system 100. Computing system 100 can include communications interface 140, which can generally govern and manage the user input and system output, and also connect computing system 100 to other nodes in a network. There is no restriction on operating on any particular hardware arrangement and therefore the basic features here may easily be substituted for improved hardware or firmware arrangements as they are developed.

In various embodiments, the input device 145 may be one or more human interface devices or a connector to one or more human interface devices in the VIS. In some examples, the one or more human interface devices may be a microphone, a speaker, headphones, a headset, motion input, other speech input, a display, or any input or output device for a computer. The one or more human interface devices may be operable to capture verbal commands from a user. The connector for the one or more human interface devices may be wired or wireless. In an example, the microphone and/or speaker may be connected to the verbal interface system via a wired connection. In another example, the microphone and/or speaker may be enabled to interface with the verbal interface system via radio frequency communication such as a Bluetooth radio in a standard Bluetooth headset or over WiFi. For example, a standard Bluetooth headset may be used to interact with the verbal interface system, allowing the user the ability to work away from the CCD display, control the VIS, and enter data to the CCD.

In some embodiments, the VIS may be equipped with alternative human interface devices, for example, gesture recognition systems, EEG interpretation devices, etc. which can be employed as alternatives to verbal utterances to control the CCD through keyboard and mouse emulation, thereby allowing any CCD to be controlled through a variety of human interface devices without the need for reprogramming the CCD, or knowledge of the source code controlling the CCD.

In various embodiments, the output device 135 may be a connection interface which provides a means to connect the VIS to the CCD and control a mouse, keyboard, and/or display of the CCD. Non-limiting examples of a connection interface include one or more wires/cables (e.g. USB 2, USB 3.0, USB 3.1, USB-C, HDMI, DisplayPort, VGA, DVI,) or a radiofrequency connection. The VIS may connect to both a CPU and a video display of the CCD. The VIS may therefore may be connected to the CCD using one or more connections. In some embodiments, the means to connect to the CCD may be a USB interface. The USB interface may simultaneously engage the mouse and keyboard standard interface on the CCD. In at least one non-limiting example, the USB interface may be a serial USB 3.1 interface to the host computer. In another example, the USB interface may be a USB 2 interface. A preferred wired connection to the CCD may include a USB 3.0, USB 3.1, or USB-C connection, which may allow transmission of keyboard and mouse commands to the CCD, and video display information from the CCD to the VIS. The components of the VIS may be connected to each other by a wired connection, or elements may be connected by a radiofrequency connection, such as a Bluetooth earpiece.

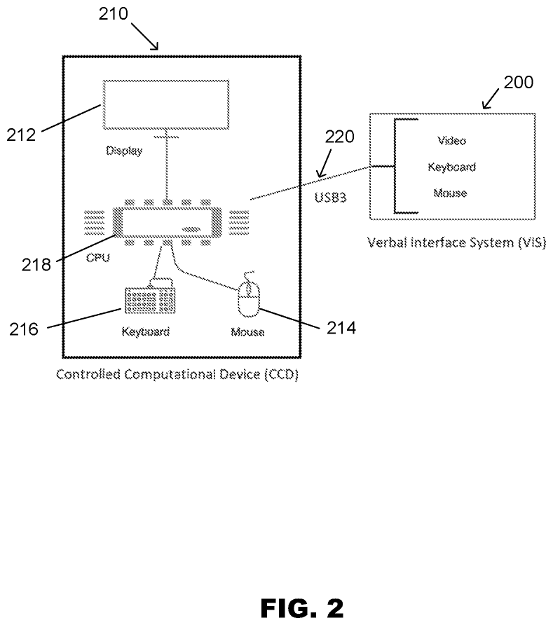

In an embodiment, as seen in FIG. 2, the VIS 200 may connect to the CCD 210 over a USB 3 (e.g. USB 3.0 or USB 3.1) or USB-C interface 220. In this embodiment, a single wire USB 3 interface 230 allows both control and monitoring of the CCD 210 by the VIS 200. The VIS 200 connects to video (e.g. a display) 212, a mouse 214, and/or a keyboard 216 of the CCD 210 via the USB 3 interface 220 to a CPU 218 of the CCD 210.

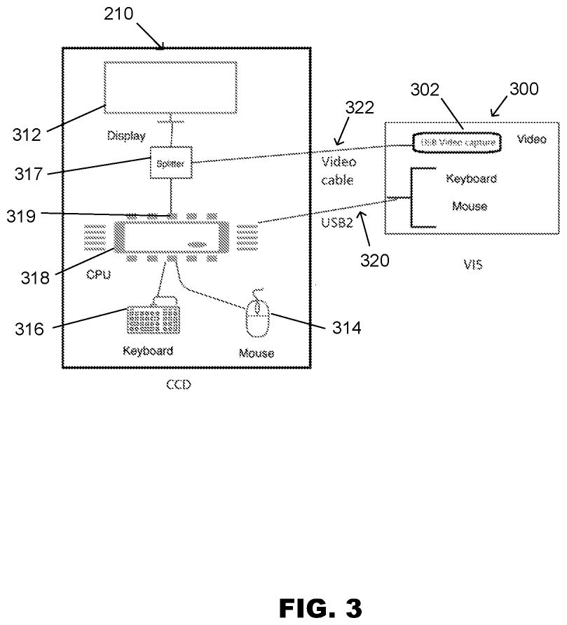

In another embodiment, as seen in FIG. 3, the VIS 300 may connect to the CCD 310 over a USB 2 interface 320 and a video cable 322. In this embodiment, the CCD 310 does not have a USB 3 interface. The VIS 300 connects to video (e.g. a display) 312 via the video cable 322 and the VIS 300 connects to a mouse 314 and/or a keyboard 316 of the CCD 310 via the USB 2 interface 320 to a CPU 318 of the CCD 310. In an example, video capture may be enabled through the use of a video splitter 317 placed within the video output connector 319 of the CCD 310 and sent to the VIS 300 using a USB3 video capture device 302.

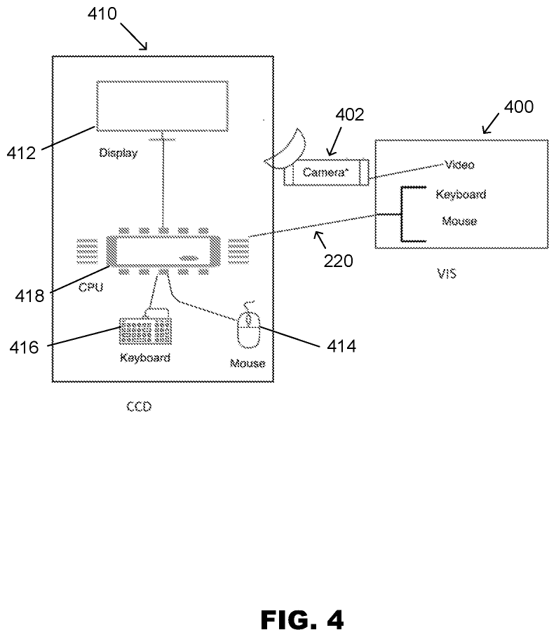

In an embodiment, as seen in FIG. 4, the VIS 400 may connect to the CCD 410 over a USB 2 interface 420. The VIS 400 connects to a mouse 414 and/or a keyboard 416 of the CCD 410 via the USB 2 interface 420 to a CPU 418 of the CCD 410. The VIS 400 may optionally include a video screen capture device (e.g. a video camera) 402. The video camera 402 may be used to allow video conferencing over the VIS with a remote consultant and/or to capture a medical examination. The video camera 402 may also capture the display 412 of the CCD 410 for those systems that lack a video output either by USB connection or hardware video connector.

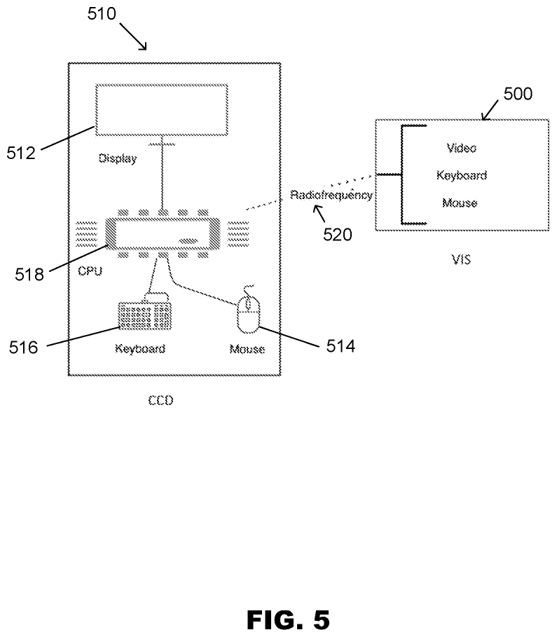

In another embodiment, as seen in FIG. 5, the connection from the VIS 500 to the CCD 510 may be a radiofrequency connection 520. The VIS 500 connects to video (e.g. a display) 512, a mouse 514, and/or a keyboard 516 of the CCD 510 via the radiofrequency connection 520 to a CPU 518 of the CCD 510. In an example, the radiofrequency connection 520 is a Bluetooth connection.

The VIS may include additional output devices, such as USB ports, radios (such as Zigbee or other controlling protocols), or infrared output devices to allow interfacing to, and control of, other medical devices.

In various embodiments, the connections interface 140 may be the network connection for the VIS. The network connection may be wired or wireless. In some examples, a radiofrequency connection to the Internet such as a WiFi or by a 5G network connection may be used as an alternative to a wired network connection.

Storage device 130 can be a non-volatile memory device and can be a hard disk or other types of computer readable media which can store data that are accessible by a computer, such as magnetic cassettes, flash memory cards, solid state memory devices, digital versatile disks, cartridges, battery backed random access memories (RAMs), read only memory (ROM), and/or some combination of these devices.

The storage device 130 can include software services, servers, services, etc., that when the code that defines such software is executed by the processor 110, it causes the system to perform a function. In some examples, a hardware service that performs a particular function can include the software component stored in a computer-readable medium in connection with the necessary hardware components, such as processor 110, connection 105, output device 135, etc., to carry out the function.

The VIS is controlled by software located within the storage device 130 of the system 100 and/or augmented by downloaded software through the network interface which makes it adaptable to a variety of scenarios based on the characteristics of the CCD being controlled. The software in the VIS may be operable to recognize speech by the user (for example, an activation word or a voice request), identify elements on a display that can be interacted with, interpret the voice request of the user in relation to the elements on the display, and autonomously control a mouse and/or keyboard of the CCD based on the voice request to properly select and/or input information into the elements on the display.

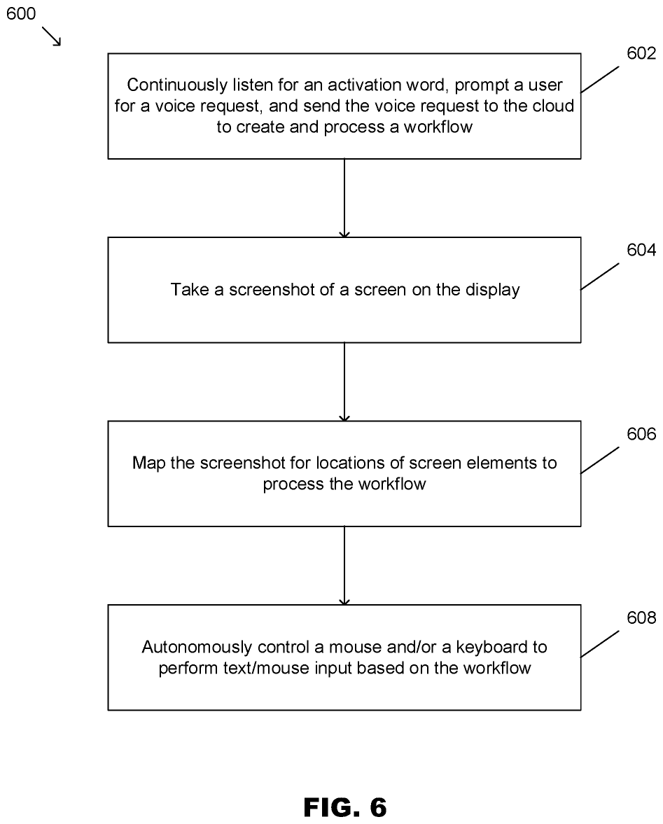

The overall framework of a method 600 to verbally control a CCD using the VIS is shown in FIG. 6. The method 600 may be executed by the processor 110 and the memory may store instructions for performing one or more steps of method 600.

At step 602, the method 100 may include continuously listening for an activation word. Upon identifying an activation word, the VIS may prompt a user by asking for a command/voice request using a voice recognition system. In some examples, the prompt may be a beep. The VIS may then send the voice request to a cloud service for processing and analysis. The cloud service may then return a response with flagged elements said in the voice request as arguments used to create and process a workflow.

At step 604, the method 600 may include taking at least one screenshot or video (e.g. screen capture, video capture) of the current screen of the display of the CCD when viewing a screen for the first time. In an embodiment, the VIS may be operable to capture the video screen from the display of the CCD, read text from the screen capture, store the screen capture, and output the screen's information via text. In other embodiments, the VIS may present the content of the display audibly to the user, thereby allowing interaction and control of the CCD through the VIS. In this way visually impaired individuals can use any CCD or use of CCD can be enabled when attention to a display is not possible.

Video capture of the CCD may be optimized to allow any CCD to be controlled by the VIS. In such an example, the verbal interface system may further include a local monitor, a video capture device (e.g., a video capture board), and a video splitter to allow video to be captured, processed, and presented back to the host display screen. In another example, capture of the host computer display can be performed by a high resolution camera positioned in front of the host computer display to capture the screen and transmit it to the verbal interface system. The VIS video from the CCD may be used to educate the VIS allowing feedback for correction of any errors created by verbal control.

At step 606, the method 600 may include mapping the screen or video capture for all the locations of screen elements necessary to process a workflow. This may include analyzing at least one screen or video capture to determine a plurality of data entry fields displayed on the CCD display. In some examples, the plurality of data entry fields comprises patient information or treatment information. Without these locations, the mouse wouldn't know where to move on screen. In simple control scenarios, the VIS identifies specific areas on the display of the CCD which, when clicked upon by the mouse, initiate specific activity by the CCD (e.g. buttons). The VIS detects any text located on the buttons and uses this text to interpret what is being said by the user. If the user speaks the text, the system moves the cursor over and depresses the button, initiating the action. This eliminates the need for the user to have manual interaction with the CCD. For more complex cases the VIS records and analyzes how the user is manually entering data into the CCD.

Alternatively to steps 604 and 606, the VIS may have internal or direct access to software on the CPU of the CCD. For example, the VIS may have access to tags used by software developers to label the icons and buttons in the software interface on the CCD. This may allow for mapping of the screen elements without taking a screenshot of the display.

At step 608, the method 600 may include autonomously controlling a mouse and/or keyboard to perform text/mouse input into the CCD. The mouse and/or keyboard may be autonomously controlled by emulating mouse input and/or keyboard input via the USB interface. The emulation may select of one of the plurality of data entry fields and/or enter an alphanumeric sequence into the one of the plurality of data entry fields selected. The verbal input and generated workflow from the user at step 602 may be used to identify where a mouse should navigate or click and or what text should be entered in which field. For example, the flagged elements in the cloud service response may be used as input arguments when interacting with text fields or buttons. In some aspects, rather than using a mouse/keyboard to perform text/mouse input, the voice recognition system may directly pass flagged arguments to the software system internals on the CPU of the CCD using the aforementioned tags. The tags represent containers to be filled with data, regardless of location.

In some embodiments, the VIS may generate a plurality of prompts if the workflow from the initial verbal commands does not match the identified data entry fields. Each one of the plurality of prompts may correspond to one of the plurality of data entry fields. The prompts may be provided via a speaker.

An advantageous aspect of the VIS is that the USB interface may simultaneously simulate the mouse and keyboard standard interface. This allows control of the standard system by emulating keyboard and mouse input while allowing full use of the standard interface. In this fashion, everything that can be done with the keyboard and mouse can be performed verbally using the verbal system as it interacts with the standard interface via USB. By emulating both a mouse and keyboard, the VIS can position the cursor directly over an interactable screen element to allow precise data entry or virtual button pushes. Keyboard and mouse hardware systems use a standard USB protocol to communicate with host computers, which allows the VIS to emulate both precisely, and thereby allow the use of the VIS on literally every personal computer now in use. Further, as such a protocol is mandatory for all computers to allow control, the device may be used on computers that are “locked down” and do not allow modification of any software; by “mocking” a keyboard and a mouse the VIS enables control without changing any settings, or loading any software, on the CCD.

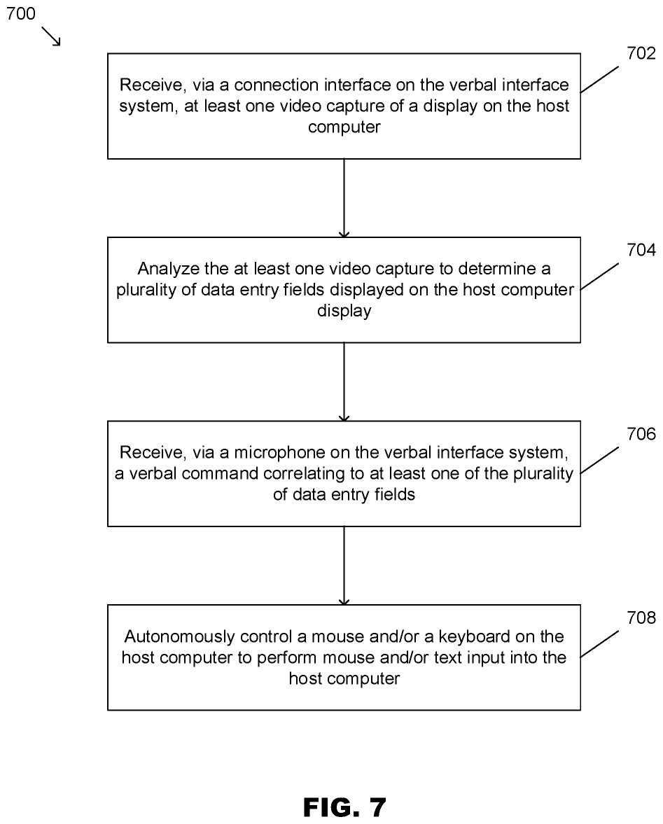

FIG. 7 provides a flow diagram of another method 700 for verbally controlling a CCD using a VIS. At step 702, at least one video capture of a display on a host computer may be received via a connection interface on the VIS. At step 704, the at least one video capture may be analyzed to determine a plurality of data entry fields displayed on the host computer display. At step 706, a verbal command correlating to at least one of the plurality of data entry fields may be received via a microphone on the VIS. At step 708, a mouse and/or keyboard on the host computer may be autonomously controlled to perform mouse and/or text input into the host computer. In some embodiments, autonomously controlling the mouse and/or the keyboard includes transmitting to the host computer a selection of one of the plurality of data entry fields and/or an alphanumeric sequence to be entered into the one of the plurality of data entry fields selected. The transmission to the host computer may be done via the connection interface by emulating mouse input and/or keyboard input.

In some embodiments, the method 600, 700 may optionally include generating a plurality of prompts, each one of the plurality of prompts corresponding to one of the plurality of data entry fields. The VIS may then audibly suggest the plurality of prompts. The VIS may provide the prompts via a speaker on the VIS.

The VIS, through its network connection, may have access to speech recognition software, so that as the system finds patterns in which speech could become useful, verbal prompts may be generated, and the user may speak to the system to control data entry. In some embodiments, the method 600, 700 may optionally include translating the verbal command, via the speech recognition software, into a selection of one of the plurality of data entry fields corresponding to the one of the plurality of prompts indicated.

In some embodiments, the method 600, 700 may optionally include capturing at least one video capture using a video screen capture device in connection with the connection interface and a video output port of the CCD/host computer. The at least one video capture may then be displayed using an external display monitor in connection with the CCD/host computer and the video screen capture device.

In some embodiments, the method 600, 700 may optionally include steps to validate the success of inputs or task completion. For example, the method may include checking if the task was completely executed. In some aspects, a user may further check for accuracy of the inputs.

In some embodiments, the method 600, 700 may optionally include steps to capture and store screen analysis performed when mapping the locations of the screen elements. In some examples, the capture and storage of the screen analysis may be done for testing purposes. An advantage of the VIS is the ability to create an archive of display screens that have been captured (this archive may be maintained either locally or in the cloud depending on privacy settings). In such an example, the verbal interface system is configured to capture not only what is displayed on the screen generated by the CCD but is further configured to focus on field descriptors or virtual buttons that produce specific actions. The archive of captured displays may allow the VIS to recognize a specific CCD upon first use, thereby providing knowledge to the system to expedite use by first time users.

In some embodiments, the method 600, 700 may optionally include steps to log the workflow by writing in a text file commands/workflows requested by the user. In some examples, the logging of the workflow may be done for testing purposes.

In some embodiments, the method 600, 700 may optionally include steps to identify a user of the VIS. The processor 110 may be operable to identify the user may be through analysis of speech of the user, the use of a verbal username password combination, or other biometric means, such as a fingerprint reader. The VIS may be capable of storing video captures of the CCD display and may have software configured to analyze how the user interacts with the CCD and the typical pattern of data entry.

An advantage of the VIS is that the interaction with the CCD, and the verbal commands given to the user and the commands generated by the user, may all be specific for that user identified, making certain that the user would not have to deviate from their normal process of data entry to use the verbal interface. By identifying the user securely, the system may give an additional level of security to sensitive computation systems by demanding an additional level of identification.

In some embodiments, method 600, 700 may further include automatically controlling the mouse or keyboard of the CCD without direct verbal input from the user for each entry. For example, method 600, 700 may further include observing manual data entry performed via the mouse and the keyboard via the at least one video capture of the host computer display, analyzing the video capture to determine a pattern of manual data entry, and generating ways to allow verbal data entry without interrupting the pattern of manual data entry.

In some embodiments, after the detection of repeated, stereotypical entry, the VIS may suggest and implement a verbal command to accomplish the data entry without manual interaction with the mouse, keyboard, or video screen. For example, a user may examine a patient, determine that the examination is normal, and say “enter a normal exam” to document an entire physical examination without manual entry. Thus, the VIS may use machine learning to enact verbal prompting of the user to create a series of keyboard entries and mouse movements for documentation or activation of any CCD while not impeding any and all conventional manual interaction with the CCD is so desired by the user. In essence the VIS serves as a learning assistant who, upon repeated exposure to the user's interaction with the CCD, can automate any and all tasks.

In some embodiments, all verbal commands may be selected by the user and trained to the VIS. In other embodiments, the VIS may use text located on the display to train the VIS. In additional embodiments, the user may use the VIS without any learning to perform simple tasks such as verbally moving the cursor from data field to data field, or to depress specifically labelled buttons. Alternatively, the full utility of the VIS may be realized with the system learning how the user interacts with the CCD, and creating a means to allow verbal commands to complete data entry, or initiate action on the part of the CCD, without interrupting the usual manual pattern of interaction, as the VIS would appear to simply be a second keyboard and mouse to the CCD.

In some embodiments, the system may learn about workflows and then suggest them to the user after completing a task. The VIS may learn from the video capture and the mouse/keyboard commands given by the user to understand how data is being entered, and after sufficient training may suggest and implement verbal techniques to accomplish data entry without manually interacting with the mouse, keyboard, or video screen. These suggestions can be altered, renamed, or deleted by the user at will, and may be created for the specific user identified by the user identification means described above.

When using the standard interface the user may either type into specific fields on the screen or interact with specific features (e.g. virtual buttons) to enter data into and control the CCD. The verbal interface system is connected to the CCD and is able to capture and analyze how the user is interacting with the screen via the standard interface.

By analyzing how the user interacts with the CCD, the VIS can determine, through machine learning, what items on the screen are generated by the host system, and what fields, normally blank, are used for data entry, as well as the pattern employed by the user to fill out the form. The VIS may then generate, and suggest, the appropriate commands to allow interaction with the elements on the video screen.

For example, in medical record keeping, when a data entry form is displayed by the CCD with a button labelled “Last Name”; the VIS may identify the blank field as requiring a patient's name, and use a mouse and keyboard emulation to overlay the field name with the verbal command given by the user consisting of the patient's name. Alternatively, the user may say the field name, the verbal interface would understand what is being entered, and the next utterance from the user may consist of the name of the patient, which would be understood by the speech recognition software of the VIS, and typed into the blank field using the keyboard interface.

As the VIS interacts with the user it can learn standard ways of interaction which may automate the input of data. For example, when encountering a new patient, it would be expected that the patient's name, date of birth, sex, home address, and phone number would be entered in sequence on the first encounter. The system may learn that these data items are routinely entered in consecutive fashion; it may therefore prompt the use with a verbal suggestion, such as “are you entering a new patient?”, and once the user verbally indicates that is occurring, the system would ask for each data element in sequence, with the user giving a verbal response to each data item, which may then be typed into the standard system using the verbal interface. During a medical examination, the medical professional may be able to teach the system the order in which the examination is performed, and as the examination occurs, with hands of the professional on the patient, the system would wait for the professional to give their findings, which would be verbally captured then typed into the appropriate field in the medical record. This may eliminate a key source of medical frustration with electronic health records in that findings may be recorded as discovered, as opposed to remembered and then documented subsequently, increasing the time spent by the professional.

In some embodiments, the VIS may spontaneously generate an archive of scenarios, based upon its observation of the use of the standard system, by which a VIS may be employed as a substitute for typing. Further, as the VIS is aware of what is occurring on the CCD, if the user reverts to manual typing and mouse control, the VIS may pause any verbal input string, and take up again once typing has stopped, and the user has indicated that verbal input should commence. The user may be free to determine in real time the most efficient way to interact with the standard interface.

In some embodiments, the VIS may allow the user, at their sole request, to have the system interact with intelligent systems based on the web to allow remote consultation. For example, an emergency room physician, looking at lab data from a patient, may verbally enable screen sharing with a remote consultant, allowing the consultant to review the findings, suggest a diagnosis, or indicate the need for further workup. By placing a verbally controlled firewall between the CCD and the remote user (as described in U.S. Pat. No. 8,626,953, the contents of which are incorporated herein) the local user may allow full access to the medical record, such that the remote consultant may see imaging, lab results, prior examinations, etc. and render a more inclusive diagnosis or plan of care. Further, by equipping the VIS with additional control interfaces, the remote consultant may query and control devices at the site of the user thereby improving the care given and optimizing settings of local devices. This ability to share the medical record of a specific patient completely with a remote consultant based on an utterance by the local user would allow the seamless use of telemedicine throughout the world, all while maintaining complete control by the local user.

Having described several embodiments, it will be recognized by those skilled in the art that various modifications, alternative constructions, and equivalents may be used without departing from the spirit of the invention. Additionally, a number of well-known processes and elements have not been described in order to avoid unnecessarily obscuring the present invention.

Those skilled in the art will appreciate that the presently disclosed embodiments teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A verbal interface system for a host computer for performing data entry, the host computer having a standard interface including a mouse, a keyboard, and a display, the verbal interface system comprising:
at least one connection interface in communication with the host computer;
a memory device;
a verbal interface software program stored on the memory device;
a microphone; and
a processor configured to execute instructions stored on the verbal interface software program to:
receive, via the connection interface, at least one video capture of the host computer display;
analyze the at least one video capture to determine a plurality of data entry fields displayed on the host computer display;
receive, via the microphone, a verbal command correlating to at least one of the plurality of data entry fields; and
autonomously control the mouse and/or the keyboard to perform mouse and/or text input into the host computer.

2. The verbal interface system of claim 1, further comprising a speaker, wherein the processor is further configured to:
generate a plurality of prompts, each one of the plurality of prompts corresponding to one of the plurality of data entry fields; and
suggest, via the speaker, the plurality of prompts.

3. The verbal interface system of claim 1, further comprising at least one network connection port in communication with a network, the network having access to a speech recognition program, wherein the processor is further configured to:
translate the verbal command, via the speech recognition software, into a selection of the one of the plurality of data entry fields corresponding to the one of the plurality of prompts indicated.

4. The verbal interface system of claim 1, wherein autonomously controlling the mouse and/or the keyboard to perform mouse and/or text input into the host computer comprises:
transmitting to the host computer, via the connection interface, by emulating mouse input and/or keyboard input, a selection of one of the plurality of data entry fields and/or an alphanumeric sequence to be entered into the one of the plurality of data entry fields selected.

5. The verbal interface system of claim 1, wherein:
the at least one connection interface is a USB 3 interface.

6. The verbal interface system of claim 1, wherein:
the at least one connection interface is a USB 2 interface.

7. The verbal interface system of claim 6, further comprising:
a video screen capture device in connection with the USB 2 interface and a video output port of the host computer; and
an external display monitor in connection with the host computer and the video screen capture device.

8. The verbal interface system of claim 1, wherein:
the at least one connection interface is a radiofrequency connection.

9. The verbal interface system of claim 1, wherein:
the at least one video capture of the host computer display is a plurality of video captures obtained during manual data entry performed via the mouse and the keyboard; and
the processor is further configured to:
analyze the video capture to determine a pattern of manual data entry, and
generate ways to allow verbal data entry without interrupting the pattern of manual data entry.

10. The verbal interface system of claim 1, wherein the plurality of data entry fields comprises patient information or treatment information.

11. A method of performing data entry on a host computer using a verbal interface system, the method comprising:
receiving, via a connection interface on the verbal interface system, at least one video capture of a display on the host computer;
analyzing the at least one video capture to determine a plurality of data entry fields displayed on the host computer display;
receiving, via a microphone on the verbal interface system, a verbal command correlating to at least one of the plurality of data entry fields; and
autonomously controlling a mouse and/or a keyboard on the host computer to perform mouse and/or text input into the host computer.

12. The method of claim 1, further comprising:
generating a plurality of prompts, each one of the plurality of prompts corresponding to one of the plurality of data entry fields; and
suggesting, via a speaker on the verbal interface system, the plurality of prompts.

13. The method of claim 1, further comprising:
translating the verbal command, via a speech recognition software accessible to the verbal interface system through at least one network connection, into a selection of the one of the plurality of data entry fields corresponding to the one of the plurality of prompts indicated.

14. The method of claim 1, wherein autonomously controlling the mouse and/or the keyboard to perform mouse and/or text input into the host computer comprises:
transmitting to the host computer, via the connection interface, by emulating mouse input and/or keyboard input, a selection of one of the plurality of data entry fields and/or an alphanumeric sequence to be entered into the one of the plurality of data entry fields selected.

15. The method of claim 1, wherein:
the at least one connection interface is a USB 3 interface.

16. The method of claim 1, wherein:
the at least one connection interface is a USB 2 interface.

17. The method of claim 6, further comprising:
capturing the at least one video capture using a video screen capture device in connection with the USB 2 interface and a video output port of the host computer; and
displaying the at least one video capture using an external display monitor in connection with the host computer and the video screen capture device.

18. The method of claim 11, wherein:
the at least one connection interface is a radiofrequency connection.

19. The method of claim 11, further comprising:
observing manual data entry performed via the mouse and the keyboard via the at least one video capture of the host computer display;
analyzing the video capture to determine a pattern of manual data entry; and
generating ways to allow verbal data entry without interrupting the pattern of manual data entry.

20. The method of claim 1, wherein the plurality of data entry fields comprises patient information or treatment information.
